(19) United States
(12) Patent Application Publication
(10) Pub. No.: US 2026/0026489 A1
(43) Pub. Date: Jan. 29, 2026

(54) BOOM SPRAYER NOZZLE SPACING ADAPTER

(71) Applicant: Pentair Flow Technologies, LLC, Delavan, WI (US)

(72) Inventors: Jason Jirjis, Plymouth, MN (US); Jeff Hermes, Shoreview, MN (US); Hannah Olson, Lino Lakes, MN (US)

(21) Appl. No.: 19/283,632

(22) Filed: Jul. 29, 2025

Related U.S. Application Data
(60) Provisional application No. 63/676,735, filed on Jul. 29, 2024.

(51) Int. Cl. A01M 7/00; A01C 23/04; B05B 1/20; B05B 15/658

(52) U.S. Cl. CPC A01M 7/006; B05B 1/202; B05B 15/658; A01C 23/047

(57) ABSTRACT

A boom sprayer assembly including a boom, a plurality of fluid connectors fluidly coupled to the boom, and one or more nozzle spacing adapters respectively fluidly coupled to one or more of the plurality of fluid connectors is provided. The plurality of fluid connectors are evenly distanced from one another at a first spacing interval. The one or more nozzle spacing adapters include at least one adapter outlet, and the at least one adapter outlet defines an offset spacing interval with the plurality of fluid connectors that is different than the first spacing interval.

### RELATED APPLICATIONS

The present application claims priority to U.S. Provisional Application No. 63/676,735 filed Jul. 29, 2024, the content of which is hereby incorporated by reference in its entirety.

### BACKGROUND

Traditional boom sprayers for spraying agricultural crops with various treatments are equipped with nozzles that are spaced evenly to match the spacing of the rows of crops. The entire boom of conventional boom sprayers often must be exchanged to spray crops grown at differing row spacing intervals. However, exchanging boom sprayers requires time, effort, and often specialized tools. Thus, it would be useful to provide more sophisticated and versatile devices and methods to spray differently spaced crop rows.

### SUMMARY

Some embodiments provide a boom sprayer assembly including a boom, a plurality of fluid connectors fluidly coupled to the boom, and one or more nozzle spacing adapters respectively fluidly coupled to one or more of the plurality of fluid connectors. The plurality of fluid connectors are evenly distanced from one another at a first spacing interval. The one or more nozzle spacing adapters include at least one adapter outlet, and the at least one adapter outlet defines an offset spacing interval with the plurality of fluid connectors that is different than the first spacing interval.

In some embodiments, each of the plurality of fluid connectors has a valve that is configured to selectively open or close. In some embodiments, the offset spacing interval is longer than the first spacing interval. In some embodiments, the offset spacing interval is shorter than the first spacing interval. In some embodiments, the adapter outlets are positioned along an outlet plane such that the diameter of each of the adapter outlets is substantially aligned with the outlet plane. In some embodiments, the one or more nozzle spacing adapters are configured to fluidly connect with two of the plurality of fluid connectors. In some embodiments, two of the plurality of fluid connectors are adjacent to one another along the boom.

In some embodiments, the one or more nozzle spacing adapters include a curved connector tube. In some embodiments, the one or more nozzle spacing adapters include a rectilinear connector tube. In some embodiments, the rectilinear connector tube has a first section connected to a second section. In some embodiments, the rectilinear connector tube includes a rigid material. In some embodiments, the one or more nozzle spacing adapters include a first outlet and a second outlet. In some embodiments, the first outlet is horizontally distanced from the second outlet by the offset spacing interval, and the second outlet aligns with a fluid connector outlet of one of the plurality of fluid connectors, the fluid connector outlet being coupled to one of the nozzle spacing adapters.

Some embodiments provide a boom sprayer adapter for selectively adjusting a spray interval between adjacent fluid connectors fluidly coupled along a boom sprayer, the boom spray adapter including a first adapter inlet adapted for connection to a first connector outlet of a first boom sprayer fluid connector, a first adapter outlet, and a first rigid connector tube. The first rigid connector tube fluidly connects the first adapter inlet with the first adapter outlet. An adapter spray interval is defined between the first adapter outlet and a second connector outlet of a second boom sprayer fluid connector, the adapter spray interval being different than a connector spray interval defined between the first connector outlet and the second connector outlet.

In some embodiments, the boom sprayer adapter includes a second adapter inlet adapted for connection to the second connector outlet and a second connector tube fluidly connected to the first adapter outlet. In some embodiments, the first rigid connector tube includes at least one of a curved connector tube or a rectilinear connector tube. In some embodiments, the boom sprayer adapter includes a second adapter outlet fluidly coupled to the first rigid connector tube.

Some embodiments provide a method to adjust boom sprayer nozzle spacing. The method includes determining a desired spacing pattern of spray outlets along a boom, selecting one or more nozzle spacing adapters based on the desired spacing pattern, and mounting the one or more nozzle spacing adapters to one or more of a plurality of fluid connectors fluidly coupled to the boom. The plurality of fluid connectors define a boom spacing pattern, and the one or more nozzle spacing adapters and the plurality of fluid connectors define the desired spacing pattern that differs from the boom spacing pattern.

In some embodiments, the method includes selectively enabling one or more of the plurality of fluid connectors to further define the desired spacing pattern. In some embodiments, the desired spacing pattern includes a plurality of spacing intervals, and the method further includes selectively mounting two or more spacing nozzle adapters to the boom to define the desired spacing pattern.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a schematic view of a boom sprayer assembly, according to an embodiment;

FIG. 2 is a front view of a first nozzle spacing adapter of the boom sprayer assembly of FIG. 1;

FIG. 3 is a front view of a second nozzle spacing adapter of the boom sprayer assembly of FIG. 1;

FIG. 4 is a front view of a third nozzle spacing adapter of the boom sprayer assembly of FIG. 1;

FIG. 5 is a front view of a fourth nozzle spacing adapter of the boom sprayer assembly of FIG. 1;

FIG. 6 is an isometric view of a coupler of the first, second, third, and fourth nozzle spacing adapters of FIGS. 2-5;

FIG. 7 is an exploded view of the coupler of FIG. 6;

FIG. 8 is a top view of a ring of the coupler of FIG. 6; and

FIG. 9 is a flow diagram depicting a method to adjust a boom sprayer nozzle spacing, according to the principles of this disclosure.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to the embodiments shown but are to be accorded the widest scope consistent with the principles and features disclosed herein. The figures, which are not necessarily to scale, depict selected embodiments and are not intended to limit the scope of embodiments of the invention. Skilled artisans will recognize that the examples provided herein have many useful alternatives that fall within the scope of embodiments of the invention.

It is to be understood that the phraseology and terminology used herein are for the purpose of description and should not be regarded as limiting. For example, the use of “including,” “comprising,” or “having” and variations thereof herein is meant to encompass the items listed thereafter and equivalents thereof, as well as additional items. As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As mentioned above, current systems and methods to spray crops with different spacing intervals or spacing patterns are inefficient and inadequate. Thus, it would be useful to provide more sophisticated and versatile tools, systems, and methods to adjust the spacing intervals of the boom sprayers to match the spacing intervals of various crops.

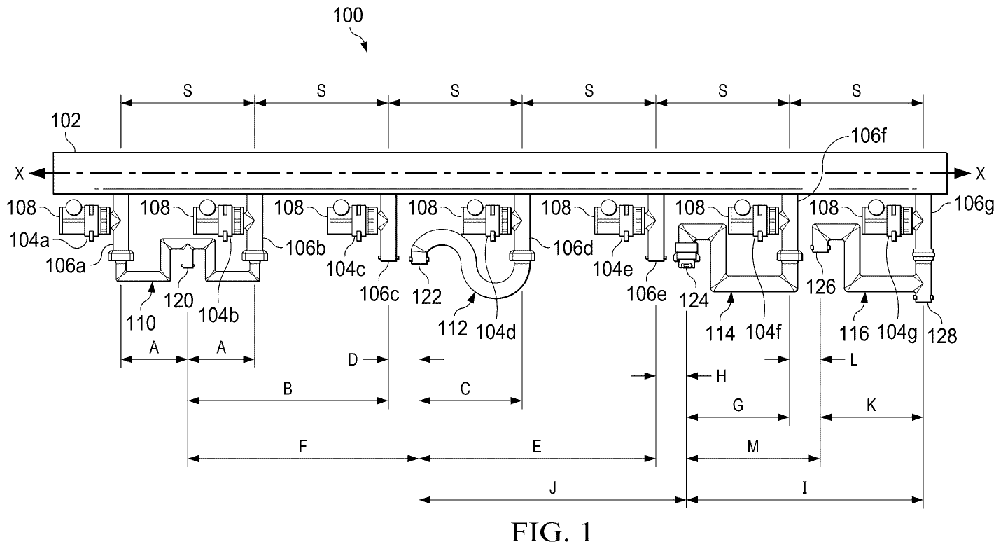

FIG. 1 illustrates a boom sprayer assembly 100 according to an embodiment. The boom sprayer assembly 100 includes a boom 102 that supports a plurality of fluid connectors 104a, 104b, 104c, 104d, 104c, 104f, 104g. The boom 102 includes an internal fluid channel that is fluidly connected to each of the fluid connectors 104a-104g to supply each fluid connector 104a-104g with a fluid, such as a chemical for treating crops.

Further, the boom 102 extends along and is substantially concentric with a boom axis X-X. Each of the plurality of fluid connectors 104a-104g includes an outlet port 106a, 106b, 106c, 106d, 106, 106f, 106g, respectively. The outlet ports 106a-106g are evenly distanced from one another in a horizontal direction along the boom axis X-X by a first spacing interval S. Even further, the boom axis X-X is positioned on an outlet plane O (not shown), and the outlet ports 106a-106g are positioned on the boom 102 such that the diameter of each of the outlet ports 106a-106g is substantially aligned with the outlet plane O, e.g., the outlet ports 106a-106g are coplanar. Accordingly, each of the outlet ports 106a-106g is configured to direct fluid out of the boom 102 in substantially the same downward direction toward the crops being treated by the fluid.

Also, each of the plurality of fluid connectors 104a-104g includes a valve 108 (e.g., a solenoid valve) that is configured to control the flow of fluid out of the respective outlet port 106a-106g. Thus, fluid flow out of the plurality of fluid connectors 104a-104g is selectively enabled (e.g., turned on or off, cycled, switched, etc.) by the respective valve 108.

As shown in FIG. 1, the boom sprayer assembly 100 can include one or more of a first nozzle spacing adapter 110, a second nozzle spacing adapter 112, a third nozzle spacing adapter 114, and a fourth nozzle spacing adapter 116. The first nozzle spacing adapter 110 is mounted to the outlet ports 106a and 106b of two fluid connectors 104a and 104b that neighbor one another, e.g., the fluid connectors 104a and 104b are positioned near one another on the boom 102, and no other fluid connectors 104 are positioned in between them. The second nozzle spacing adapter 112, the third nozzle spacing adapter 114, and the fourth nozzle spacing adapter 116 are each mounted to a respective one of the outlet ports, e.g., outlet ports 106d, 106f, 106g, respectively.

Here, the first nozzle spacing adapter 110 has a first outlet 120 that defines a first offset spacing interval A with each of the outlet ports 106a and 106b to which the first nozzle spacing adapter 110 is fluidly coupled. Further, the first outlet 120 defines a second offset spacing interval B with the neighboring outlet port 106c of the fluid connector 104c.

The second nozzle spacing adapter 112 has a second outlet 122 that defines a third offset spacing interval C with the outlet port 106d of the fluid connector 104d to which the second nozzle spacing adapter 112 is fluidly coupled. Further, the second outlet 122 defines a fourth offset spacing interval D and a fifth offset spacing interval E with the outlet ports 106c and 106c, respectively, of neighboring fluid connectors 104c and 104e, respectively. Additionally, the first outlet 120 and the second outlet 122 define a sixth offset spacing interval F with one another.

The third nozzle spacing adapter 114 has a third outlet 124 that defines a seventh offset spacing interval G with the outlet port 106f of the fluid connector 104f to which the third nozzle spacing adapter 114 is fluidly coupled. Further, the third outlet 124 defines an eighth offset spacing interval H and a ninth offset spacing interval I with the outlet ports 106e and 106g, respectively, of neighboring fluid connectors 104e and 104g, respectively. Additionally, the second outlet 122 and the third outlet 124 define a tenth offset spacing interval J with one another.

The fourth nozzle spacing adapter 116 has a fourth outlet 126 that defines an eleventh offset spacing interval K with the outlet port 106g of the fluid connector 104g to which the fourth nozzle spacing adapter 116 is fluidly coupled. Further, the fourth outlet 126 defines a twelfth offset spacing interval L with the outlet port 106f of the neighboring fluid connector 104f. The third outlet 124 and the fourth outlet 126 define a thirteenth offset spacing interval M with one another. Additionally, the fourth nozzle spacing adapter 116 has a fifth outlet 128 that aligns with the outlet port 106g of the fluid connector 104g to which the fourth nozzle spacing adapter 116 is fluidly coupled. It should be understood that each of the offset spacing intervals A-M can be defined as a horizontal distance measured along, or substantially parallel to, the boom axis X-X.

Referring further to FIG. 1, the first nozzle spacing adapter 110, the second nozzle spacing adapter 112, the third nozzle spacing adapter 114, or the fourth nozzle spacing adapter 116 may be rearranged along the boom 102 in any manner or amount to produce desired spacing adjustment offsets from the outlet ports 106a-106g. For example, any of the first nozzle spacing adapter 110, the second nozzle spacing adapter 112, the third nozzle spacing adapter 114, or the fourth nozzle spacing adapter 116 may be omitted to produce desired spacing adjustment offset intervals. Additionally, more than one of any of the first nozzle spacing adapter 110, the second nozzle spacing adapter 112, the third nozzle spacing adapter 114, or the fourth nozzle spacing adapter 116 may be mounted to various outlet ports 106a-106g of the fluid connectors 104a-104g to produce desired spacing adjustment offset intervals. Accordingly, it should be understood and appreciated that the first nozzle spacing adapter 110, the second nozzle spacing adapter 112, the third nozzle spacing adapter 114, and the fourth nozzle spacing adapter 116 can be arranged to provide a variety of spacing adjustment offset intervals with the outlet ports 106a-106g of the fluid connectors 104a-104g.

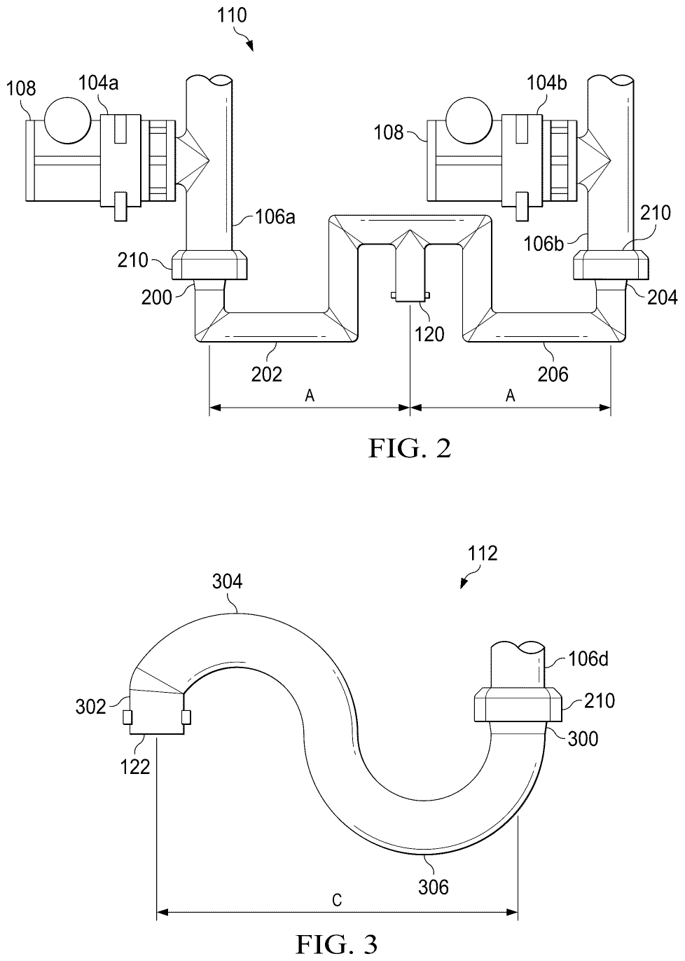

FIG. 2 illustrates the first nozzle spacing adapter 110 in additional detail. For example, the first nozzle spacing adapter 110 has a first inlet 200 and a first connector tube 202 that connects and fluidly couples the first inlet 200 to the first outlet 120. Further, the first nozzle spacing adapter 110 includes a second inlet 204 and a second connector tube 206 that connects and fluidly couples the second inlet 204 to the first outlet 120. The first connector tube 202 and the second connector tube 206 each define a rectilinear, serpentine fluid path. In some forms, the rectilinear, serpentine fluid path includes a plurality of substantially 90-degree bends. Also, the first inlet 200 and the second inlet 204 are distanced from the first outlet 120 by the first offset spacing interval A. Additionally, the first inlet 200 and the second inlet 204 each include a coupler 210.

When the first nozzle spacing adapter 110 is coupled to two neighboring fluid connectors, such as fluid connectors 104a and 104b, the outlet 120 is positioned such that with a sprayer nozzle attached, an outlet of the sprayer nozzle is substantially the same distance away from the boom axis X-X as the outlet of the sprayer nozzle would be if it were coupled to either of the outlet ports 106a or 106b directly. Accordingly, the first nozzle spacing adapter 110 and its outlet 120 are sized and shaped such that a sprayer nozzle coupled to the outlet 120 would dispense fluid at substantially the same height above a ground surface over which the boom sprayer assembly 100 is traveling as a height above the ground surface at which the sprayer nozzle would dispense fluid if it were coupled to either the outlet port 106a or the outlet port 106b directly. Further, the outlet 120 is positioned such that when the first nozzle spacing adapter 110 is coupled to two neighboring fluid connectors, the diameter of the outlet 120 is substantially aligned with the outlet plane O described above. Accordingly, the outlet 120 is configured to direct fluid out of the boom 102 in substantially the same downward direction as each of the outlet ports 106a-106g.

FIG. 3 illustrates the second nozzle spacing adapter 112 in additional detail. For example, the second nozzle spacing adapter 112 has an inlet 300 connected to the second outlet 122 via a connector tube 302. The connector tube 302 follows a curved serpentine path and can include a first arch 304 connected to a second arch 306. In some forms, the curved, serpentine path includes a plurality of 180-degree bends. The inlet 300 is distanced from the second outlet 122 by the third offset spacing interval C. Additionally, the inlet 300 includes the coupler 210.

When the second nozzle spacing adapter 112 is coupled to one of the outlet ports 106a-106g, such as the outlet port 106d, the outlet 122 is positioned such that with a sprayer nozzle attached, an outlet of the sprayer nozzle is substantially the same distance away from the boom axis X-X as the outlet of the sprayer nozzle would be if it were coupled to the outlet port 106d directly. Accordingly, the second nozzle spacing adapter 112 and its outlet 122 are sized and shaped such that a sprayer nozzle coupled to the outlet 122 would dispense fluid at substantially the same height above a ground surface over which the boom sprayer assembly 100 is traveling as the height above the ground surface at which the sprayer nozzle would dispense fluid if it were coupled to the outlet port 106d directly. Further, the outlet 122 is positioned such that when the second nozzle spacing adapter 112 is coupled to one of the outlet ports 106a-106g, the diameter of the outlet 122 is substantially aligned with the outlet plane O described above. Accordingly, the outlet 122 is configured to direct fluid out of the boom 102 in substantially the same downward direction as each of the outlet ports 106a-106g.

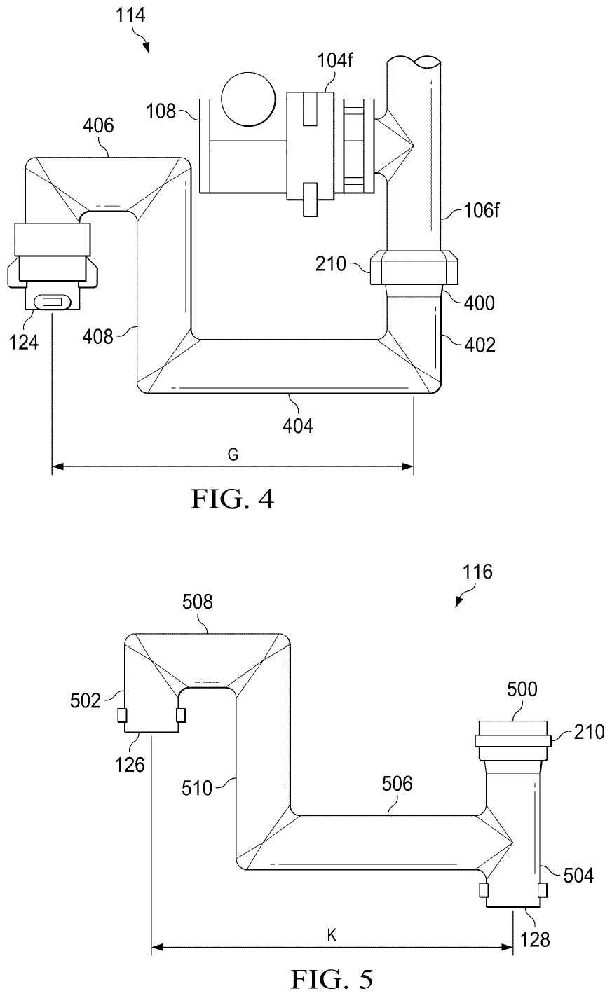

FIG. 4 illustrates the third nozzle spacing adapter 114 in additional detail. For example, the third nozzle spacing adapter 114 has an inlet 400 connected to the third outlet 124 via a connector tube 402. The connector tube 402 defines a rectilinear, serpentine fluid path. In some forms, the rectilinear, serpentine fluid path includes a plurality of substantially 90-degree bends. The connector tube 402 includes a first section 404 connected to a second section 406 via a third section 408. In some forms, the first section 404 is longer than the second section 406. Also, the inlet 400 is distanced from the third outlet 124 by the seventh offset spacing interval G. Additionally, the inlet 400 includes the coupler 210.

When the third nozzle spacing adapter 114 is coupled to one of the outlet ports 106a-106g, such as outlet port 106f, the outlet 124 is positioned such that with a sprayer nozzle attached, an outlet of the sprayer nozzle is substantially the same distance away from the boom axis X-X as the outlet of the sprayer nozzle would be if it were coupled to the outlet port 106f directly. Accordingly, the third nozzle spacing adapter 114 and its outlet 124 are sized and shaped such that a sprayer nozzle coupled to the outlet 124 would dispense fluid at substantially the same height above a ground surface over which the boom sprayer assembly 100 is traveling as the height above the ground surface at which the sprayer nozzle would dispense fluid if it were coupled to the outlet port 106f directly. Further, the outlet 124 is positioned such that when the third nozzle spacing adapter 114 is coupled to one of the outlet ports 106a-106g, the diameter of the outlet 124 is substantially aligned with the outlet plane O described above. Accordingly, the outlet 124 is configured to direct fluid out of the boom 102 in substantially the same downward direction as each of the outlet ports 106a-106g.

FIG. 5 illustrates the fourth nozzle spacing adapter 116 in additional detail. For example, the fourth nozzle spacing adapter 116 has an inlet 500 connected to the fourth outlet 126 via a first connector tube 502. Further, the inlet 500 is connected to the fifth outlet 128 via a second connector tube 504, which can extend substantially vertically downward from the inlet 500 and away from the boom 102. The connector tube 502 defines a rectilinear, serpentine fluid path. In some forms, the rectilinear, serpentine fluid path includes a plurality of substantially 90-degree bends. The first connector tube 502 can include a first section 506 connected to a second section 508 via a third section 510. In some forms, the first section 506 is longer than the second section 508. The inlet 500 and the fifth outlet 128 are distanced from the fourth outlet 126 by the eleventh offset spacing interval K. Additionally, the inlet 500 includes the coupler 210.

When the fourth nozzle spacing adapter 116 is coupled to one of the outlet ports 106a-106g, such as outlet port 106g, the outlet 126 is positioned such that with a sprayer nozzle attached, an outlet of the sprayer nozzle is substantially the same distance away from the boom axis X-X as the outlet of the sprayer nozzle would be if it were coupled to the outlet port 106g directly. Accordingly, the fourth nozzle spacing adapter 116 and the outlet 126 are sized and shaped such that a sprayer nozzle coupled to the outlet 126 would dispense fluid at substantially the same height above a ground surface over which the boom sprayer assembly 100 is traveling as the height above the ground surface at which the sprayer nozzle would dispense fluid if it were coupled to the outlet port 106g directly. Further, the outlet 126 is positioned such that when the fourth nozzle spacing adapter 116 is coupled to one of the outlet ports 106a-106g, the diameter of the outlet 126 is substantially aligned with the outlet plane O described above. Accordingly, the outlet 126 is configured to direct fluid out of the boom 102 in substantially the same downward direction as each of the outlet ports 106a-106g. Even further, the outlet 128 is also positioned such that when the fourth nozzle spacing adapter 116 is coupled to one of the outlet ports 106a-106g, the diameter of the outlet 128 is substantially aligned with the outlet plane O described above. Accordingly, the outlet 128 is configured to direct fluid out of the boom 102 in substantially the same downward direction as each of the outlet ports 106a-106g and the outlet 126.

Each of the first nozzle spacing adapter 110, the second nozzle spacing adapter 112, the third nozzle spacing adapter 114, and the fourth nozzle spacing adapter 116 can be provided in the form of prefabricated, rigid tubing. For example, the nozzle spacing adapters 110, 112, 114, 116, can comprise Polyvinyl Chloride (PVC), Polypropylene (PP), Polyethylene (PE), Polyvinylidene Fluoride (PVDF), Polytetrafluoroethylene (PTFE), Acrylonitrile Butadiene Styrene (ABS), Polyether Ether Ketone (PEEK), Polyphenylene Sulfide (PPS), other known, rigid, chemical resistant materials, and combinations thereof. In some forms, the unique spacing, curvatures, shapes, and dimensions of the nozzle spacing adapters 110, 112, 114, 116 can be provided via ultrasonic welding, epoxy adhesion, solvent welding, thermal bonding, and the like. In some forms, the prefabricated offset spacing intervals A, C, G, K of the nozzle spacing adapters 110, 112, 114, 116, respectively, are not manipulatable by the end user. If the tubing were flexible, the flexibility could allow for flow fluctuation, snagging, and potential pinching. In contrast, the nozzle spacing adapters 110, 112, 114, 116 maintain consistent flow, will not snag, will not pinch, and will preserve the precise spacing dimensions of the inlets and outlets, thus preserving the desired spray pattern onto the crops.

In some forms, the offset spacing intervals A, C, G, K between the inlets 200, 300, 400, 500 and the outlets 120, 122, 124, 126, respectively, are designed such that one or more of a particular nozzle spacing adapter 110, 112, 114, 116 and the valves 108 can be used to change a spray pattern of the boom 102 without having to entirely replace the boom 102 on the boom sprayer assembly 100. For example, the initial setup on the boom can be such that the first spacing interval S between the outlet ports 106a-106g of the fluid connectors 104a-104g is 10 inches, but a desired, modified offset interval spacing is 15 inches or 5 inches. Accordingly, any one or more of the nozzle spacing adapters 110, 112, 114, 116 can be coupled to one or more of the fluid connectors 104a-104g to provide a spray pattern that is narrower or wider than the first spacing interval S. Further, in some forms, any one or more of the nozzle spacing adapters 110, 112, 114, 116 can be used to facilitate spot spraying applications where only two, three, or four spray streams at a unique spacing interval are required.

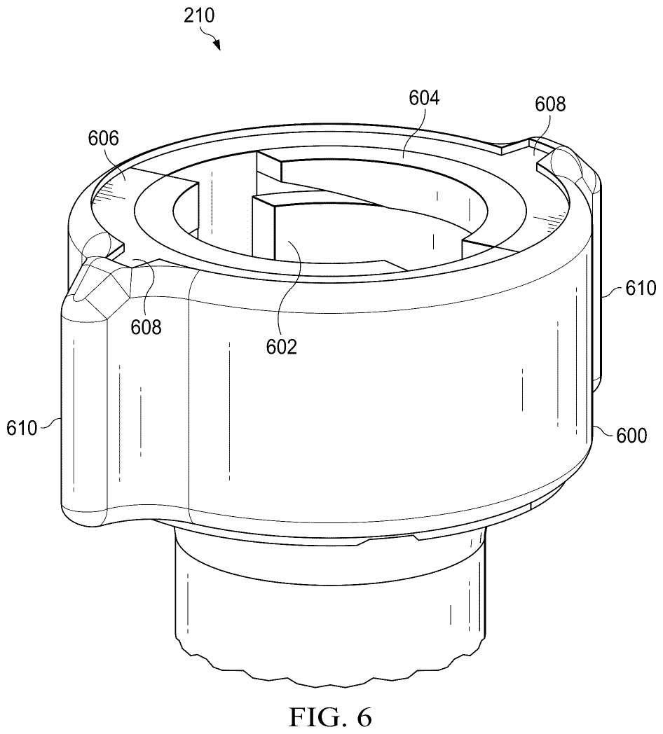

Referring to FIG. 6, the coupler 210 includes a ring 600 disposed about a base 602 with a first insert 604 and a second insert 606 connected to one another between the ring 600 and the base 602. The first insert 604 and the second insert 606 are substantially identical to one another and are rotationally fixed to the ring 600 via keys 608. Further, the ring 600 includes lobes 610 to aid in gripping the ring 600 when rotating the ring 600, the first insert 604, and the second insert 606 relative to the base 602. The coupler 210 is configured to receive and removably lock onto the fluid connectors 104a-104g (shown in FIG. 1). More specifically, in operation, the fluid connector 104a, 104b, 104c, 104d, 104c, 104f, or 104g is inserted into the coupler 210 and the first insert 604 and the second insert 606 are rotated via the ring 600 to securely couple the fluid connector 104a, 104b, 104c, 104d, 104c, 104f, or 104g to the base 602.

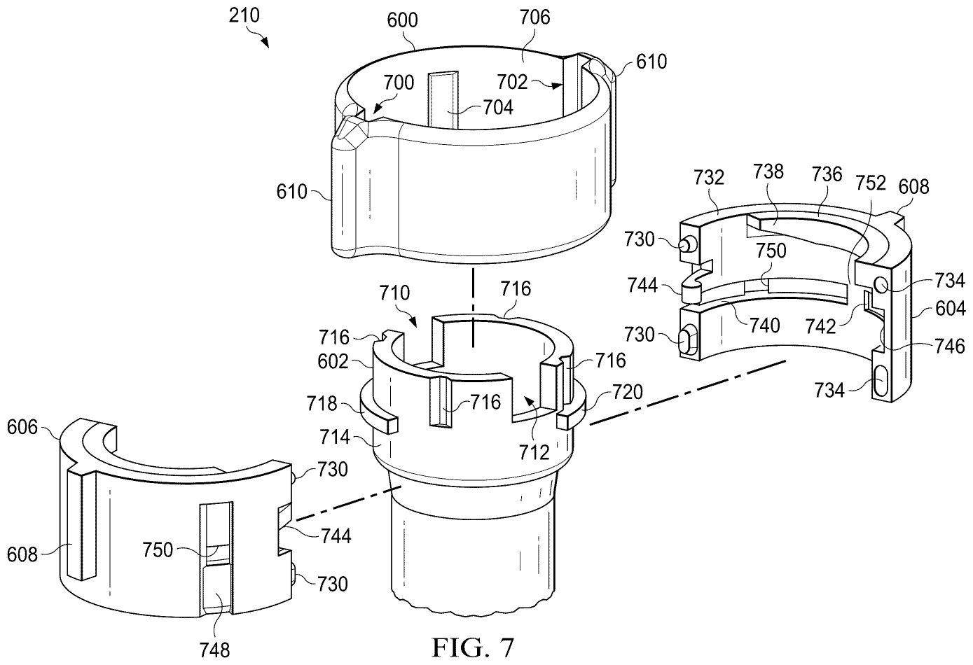

Turning to FIG. 7, the ring 600 defines a first keyway 700 and a second keyway 702, which receive the keys 608 of the first insert 604 and the second insert 606. The ring 600 further includes a first lug 704 extending radially inwardly from a cylindrical wall 706. The base 602 defines a first gap 710 and a second gap 712 in a cylindrical wall 714. Further, a plurality of indexing notches 716 are defined in the cylindrical wall 714. Additional indexing notches 716 beyond the four depicted in the example of FIG. 7 are contemplated. A first transverse guide rail 718 and a second transverse guide rail 720 extend radially outwardly from the cylindrical wall 714.

Looking further at FIG. 7, each of the first insert 604 and the second insert 606 includes connecting pins 730 extending from a semi-cylindrical wall 732 and defines respective connecting holes 734. Each of the first insert 604 and the second insert 606 also includes a locking inner flange 736 extending radially inwardly from the semi-cylindrical wall 732 and has an casing ramp 738. Further, each of the first insert 604 and the second insert 606 defines a first transverse guide slot 740 and a second transverse guide slot 742 in the semi-cylindrical wall 732. Additionally, each of the first insert 604 and the second insert 606 includes a pawl 744 and defines a respective pocket 746, which is in communication with the second transverse guide slot 742. The pawl 744 is resiliently, pivotably connected to the semi-cylindrical wall 732. Further, each of the first insert 604 and the second insert 606 defines an axial slot 748, which is in communication with the first transverse guide slot 740 via a window 750 defined in the semi-cylindrical wall 732. Additionally, each of the first insert 604 and the second insert 606 includes a stop 752 between the first transverse guide slot 740 and the second transverse guide slot 742.

When the first insert 604 and the second insert 606 are mated together, the connecting pins 730 are received in the connecting holes 734 and the pawls 744 are received in the pockets 746. Thus, the first transverse guide slot 740 of the first insert 604 communicates with the second transverse guide slot 742 of the second insert 606 and vice-versa.

Referring further to FIG. 7, when the first insert 604 and the second insert 606 are assembled about the base 602, the first transverse guide rail 718 and the second transverse guide rail 720 are received by the first transverse guide slots 740 and the second transverse guide slots 742. Thus, the first insert 604 and the second insert 606 are axially fixed to the base 602. Additionally, the pawls 744 are received by two of the indexing notches 716. As the first insert 604 and the second insert 606 rotate about the base 602, the pawls 744 resiliently snap into and are pushed out of the indexing notches 716 to removably retain the first insert 604 and the second insert 606 in a plurality of rotational positions relative to the base 602. As the first insert 604 and the second insert 606 rotate further about the base 602, the first transverse guide rail 718 and the second transverse guide rail 720 contact the stops 752. Thus, the stops 752 limit rotational movement of the first insert 604 and the second insert 606 about the base 602.

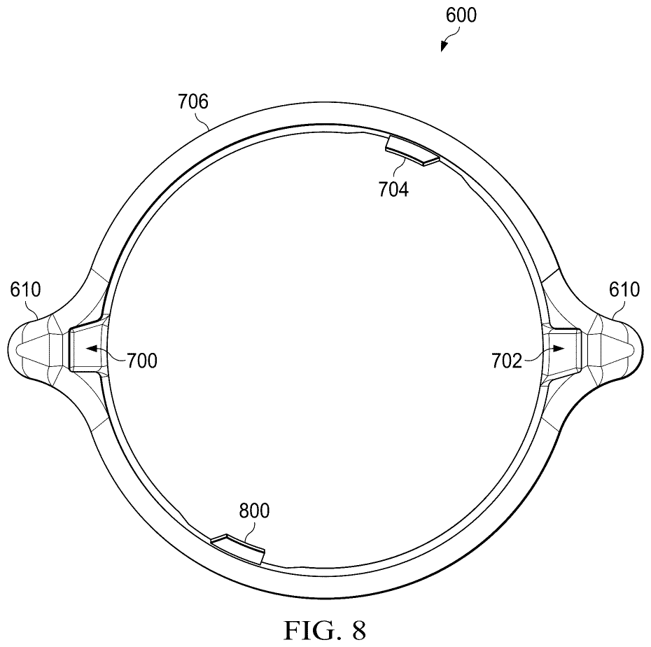

FIG. 8 illustrates the ring 600 in additional detail. The ring 600 further includes a second lug 800 extending radially inwardly from the cylindrical wall 706. When the ring 600 mates with the first insert 604 and the second insert 606 (shown in FIG. 7), the first lug 704 is received in the axial slot 748 of the first insert 604. Similarly, when the ring 600 mates with the first insert 604 and the second insert 606, the second lug 800 is received in the axial slot 748 of the second insert 606. In some embodiments, the first lug 704 and the second lug 800 fit tightly and/or interferingly into the axial slots 748. Thus, the ring 600 is connected to the first insert 604 and the second insert 606.

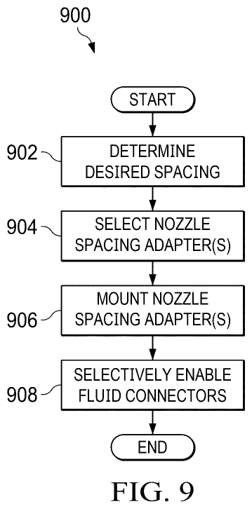

FIG. 9 illustrates a flow diagram depicting a method 900 to adjust boom sprayer nozzle spacing. The method 900 starts at step 902, where a desired spacing of sprayer nozzles along a boom sprayer is determined. More specifically, desired offset spacing intervals from an existing spacing pattern of the sprayer nozzles are determined. The method 900 proceeds to step 904.

At step 904, one or more nozzle spacing adapters (e.g., the first nozzle spacing adapter 110, the second nozzle spacing adapter 112, the third nozzle spacing adapter 114, the fourth nozzle spacing adapter 116, etc.) are selected. More specifically, the one or more nozzle spacing adapters matching the desired offset spacing intervals are chosen. The method 900 proceeds to step 906.

At step 906, the one or more nozzle spacing adapters are mounted. More specifically, the one or more nozzle spacing adapters are placed in fluid communication with the boom via the fluid connectors 104a-104g. The method 900 proceeds to step 908.

At step 908, the fluid connectors 104a-104g are selectively opened and closed via the respective valves 108. More specifically, the fluid connectors 104a-104g that form the desired spacing pattern are selectively opened (e.g., turned on) and the fluid connectors 104a-104g that are not included in the desired spacing pattern are selectively closed (e.g., turned off). The method 900 returns to step 902.

In other embodiments, other configurations are possible. For example, those of skill in the art will recognize, according to the principles and concepts disclosed herein, that various combinations, sub-combinations, and substitutions of the components discussed above can provide improved tools, device, and methods to adjust boom spraying patterns.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A boom sprayer assembly comprising:
a boom;
a plurality of fluid connectors fluidly coupled to the boom, the plurality of fluid connectors being evenly distanced from one another at a first spacing interval; and
one or more nozzle spacing adapters respectively fluidly coupled to one or more of the plurality of fluid connectors, the one or more nozzle spacing adapters including at least one adapter outlet, wherein the at least one adapter outlet defines an offset spacing interval with the plurality of fluid connectors that is different than the first spacing interval.

2. The boom sprayer assembly of claim 1, wherein each of the plurality of fluid connectors has a valve that is configured to selectively open or close.

3. The boom sprayer assembly of claim 1, wherein the offset spacing interval is longer than the first spacing interval.

4. The boom sprayer assembly of claim 1, wherein the offset spacing interval is shorter than the first spacing interval.

5. The boom sprayer assembly of claim 1, wherein the adapter outlets are positioned along an outlet plane such that the diameter of each of the adapter outlets is substantially aligned with the outlet plane.

6. The boom sprayer assembly of claim 1, wherein the one or more nozzle spacing adapters are configured to fluidly connect with two of the plurality of fluid connectors.

7. The boom sprayer assembly of claim 6, wherein the two of the plurality of fluid connectors are adjacent to one another along the boom.

8. The boom sprayer assembly of claim 1, wherein the one or more nozzle spacing adapters include a curved connector tube.

9. The boom sprayer assembly of claim 1, wherein the one or more nozzle spacing adapters include a rectilinear connector tube.

10. The boom sprayer assembly of claim 9, wherein the rectilinear connector tube has a first section connected to a second section.

11. The boom sprayer assembly of claim 10, wherein the rectilinear connector tube comprises a rigid material.

12. The boom sprayer assembly of claim 1, wherein the one or more nozzle spacing adapters include a first outlet and a second outlet.

13. The boom sprayer assembly of claim 12, wherein
the first outlet is horizontally distanced from the second outlet by the offset spacing interval, and
the second outlet aligns with a fluid connector outlet of one of the plurality of fluid connectors, the fluid connector outlet being coupled to one of the nozzle spacing adapters.

14. A boom sprayer adapter for selectively adjusting a spray interval between adjacent fluid connectors fluidly coupled along a boom sprayer, the boom spray adapter comprising:
a first adapter inlet adapted for connection to a first connector outlet of a first boom sprayer fluid connector;
a first adapter outlet; and
a first rigid connector tube,
wherein the first rigid connector tube fluidly connects the first adapter inlet with the first adapter outlet, and
wherein an adapter spray interval is defined between the first adapter outlet and a second connector outlet of a second boom sprayer fluid connector, the adapter spray interval being different than a connector spray interval defined between the first connector outlet and the second connector outlet.

15. The boom sprayer adapter of claim 14, comprising:
a second adapter inlet adapted for connection to the second connector outlet; and
a second connector tube fluidly connected to the first adapter outlet.

16. The boom sprayer adapter of claim 14, wherein the first rigid connector tube comprises at least one of a curved connector tube or a rectilinear connector tube.

17. The boom sprayer adapter of claim 14, comprising:
a second adapter outlet fluidly coupled to the first rigid connector tube.

18. A method to adjust boom sprayer nozzle spacing, the method comprising:
determining a desired spacing pattern of spray outlets along a boom;
selecting one or more nozzle spacing adapters based on the desired spacing pattern; and
mounting the one or more nozzle spacing adapters to one or more of a plurality of fluid connectors fluidly coupled to the boom, wherein
the plurality of fluid connectors define a boom spacing pattern, and
the one or more nozzle spacing adapters and the plurality of fluid connectors define the desired spacing pattern that differs from the boom spacing pattern.

19. The method of claim 18, further comprising selectively enabling one or more of the plurality of fluid connectors to further define the desired spacing pattern.

20. The method of claim 18, wherein the desired spacing pattern comprises a plurality of spacing intervals, the method further comprising:
selectively mounting two or more spacing nozzle adapters to the boom to define the desired spacing pattern.
